(19) United States
(12) Patent Application Publication
(10) Pub. No.: US 2014/0155141 A1
(43) Pub. Date: Jun. 5, 2014

(54) SYSTEMS AND METHODS TO DETERMINE A GAME PAYMENT

(71) Applicant: Zynga Inc., San Francisco, CA (US)

(72) Inventors: Aditya Kashyap, Berkeley, CA (US); Laura Louise Dansingani, San Carlos, CA (US); Kenton Kivestu, San Francisco, CA (US); Hohyun Shim, Redwood City, CA (US); Xingxing Xu, Burlingame, CA (US); Alex Leffelman, San Francisco, CA (US); Jacky Ho, San Bruno, CA (US)

(73) Assignee: Zynga Inc., San Francisco, CA (US)

(21) Appl. No.: 14/091,872

(22) Filed: Nov. 27, 2013

Related U.S. Application Data
(60) Provisional application No. 61/732,176, filed on Nov. 30, 2012.

(51) Int. Cl. G07F 17/32

(52) U.S. Cl. CPC G07F 17/3244
USPC 463/25

(57) ABSTRACT

A method of selecting players to make payments associated with a session of a game is disclosed. A player is selected to make a payment. The selecting of the player is based on a session counter of the player having a higher value than a session counter of an additional player seeking to participate in the session of the game. Based on a receiving of the payment from the selected player, the session counter of the selected player is decremented by an amount corresponding to the payment, the value of the session counter of the additional player is incremented by an amount corresponding to the payment, and the selected player and the unselected player are allowed to participate in the session of the instance of the game.

### CROSS-REFERENCE TO RELATED APPLICATIONS

This application claims the priority benefit of U.S. Provisional Application No. 61/732,176, filed Nov. 30, 2012, entitled “Game Betting Structure Including Blind Points,” which is hereby incorporated by reference in its entirety.

### TECHNICAL FIELD

The present disclosure relates to games and applications in general and in particular to computer-implemented games, such as an online game hosted on a game server.

### BACKGROUND

In various games, one or more players of the game or a sub-game of the game may be required to make predetermined bets at various points in the game. For example, in a Texas Hold 'Em poker game, at least one player at each table of the game may be required to post a “blind” bet prior to the dealing of each hand of the game. When the same players remain in the same sub-game between the points at which predetermined bets must be posted (e.g., when the same players remain seated at the same table between each hand of a poker game), one way to fairly determine which player(s) must post the required bet(s) may be to simply rotate the requirement among the players of the sub-game. In this way, a player who has just posted a pre-determined bet may not be required to post that pre-determined bet again until all of the other players in the sub-game have also posted a similar or equivalent pre-determined bet. However, in a game in which one or more players are moved between sub-games (e.g., moved to different tables of a poker game) between the points at which one or more players must make a predetermined bet, it may be more difficult to fairly choose the players in the sub-game who must make a predetermined bet.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system, according to some embodiments;

FIG. 2 is a schematic diagram showing an example of a social network within a social graph, according to some embodiments;

FIG. 3 is a block diagram showing example components of a game networking system, according to some embodiments;

FIG. 4 is a flowchart showing an example method of determining a payment owed by a player, according to some embodiments;

FIG. 5 is flowchart showing an example method to perform a “jump” from one game instance or sub-game to another game instance or sub-game, according to some embodiments;

FIG. 6 is a user interface diagram illustrating an example game user interface presenting a selection bar from which a user may select a different game instance of sub-game to jump to, according to some embodiments;

FIG. 7 is a user interface diagram illustrating an example game user interface with an option to “jump,” according to some embodiments;

FIG. 8 is a user interface diagram illustrating an example game user interface in which a player may opt to enable the “jump” feature, according to some embodiments;

FIG. 9 is a diagrammatic representation of an example data flow between example components of the example system of FIG. 1, according to some embodiments;

FIG. 10 is a schematic diagram showing an example network environment, in which various example embodiments may operate, according to some embodiments; and

FIG. 11 is a block diagram illustrating an example computing system architecture, which may be used to implement one or more of the methodologies described herein, according to some embodiments.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

Multiple players may participate in an online game comprising a plurality of sessions (or rounds), a plurality of sub-games, and a plurality of instances. Prior to each session of the online game, a subset of the players may be required to submit a payment (e.g., a bet). For example, in a poker game having players seated at multiple tables, a subset of the players seated at each table may be required to post a blind bet, such as a small blind bet or a big blind bet, before the dealing of each hand of the poker game. The subset of the players who must make the payment may be determined based on a value of a session counter corresponding to each player. The session counter may be incremented for a player after each game session in which the player is not selected to make the payment. In various embodiments, the value of the session counter corresponding to a player may be compared with one or more other values of session counters corresponding to one or more other players of the online game. In various embodiments, the one or more players having the highest session counters may be required to make the payment. Once a payment is submitted by a player, the value of the session counter for the player may be reset. Thus, any requirement for a subset of players of a sub-game to submit a payment between game sessions may be substantially fairly distributed among the players, even when players of the game are moved between sub-games of the game.

In various embodiments, a method of selecting players seeking to participate in a session of an instance of a game to make payments associated with the session of the game is disclosed. A player seeking to participate in the session of the instance of the game is selected to make a payment associated with the session of the instance of the game. The selecting of the player is based on a session counter of the player having a higher value than a session counter of an additional player seeking to participate in the session of the game. The additional player is not selected to make the payment associated with the session of the instance of the game. The session counter of the selected player represents a value of payments that the selected player was not selected to pay in previous sessions of the instance of the game. The session counter of the unselected player represents a value of payments that the unselected player was not selected to pay in the previous sessions of the instance of the game. Based on a receiving of the payment from the selected player, the session counter of the selected player is decremented by an amount corresponding to the payment, the value of the session counter of the additional player is incremented by an amount corresponding to the payment, and the selected player and the unselected player are allowed to participate in the session of the instance of the game.

This method and other methods or embodiments disclosed herein may be implemented as a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause the one or more processors to perform the instructions.

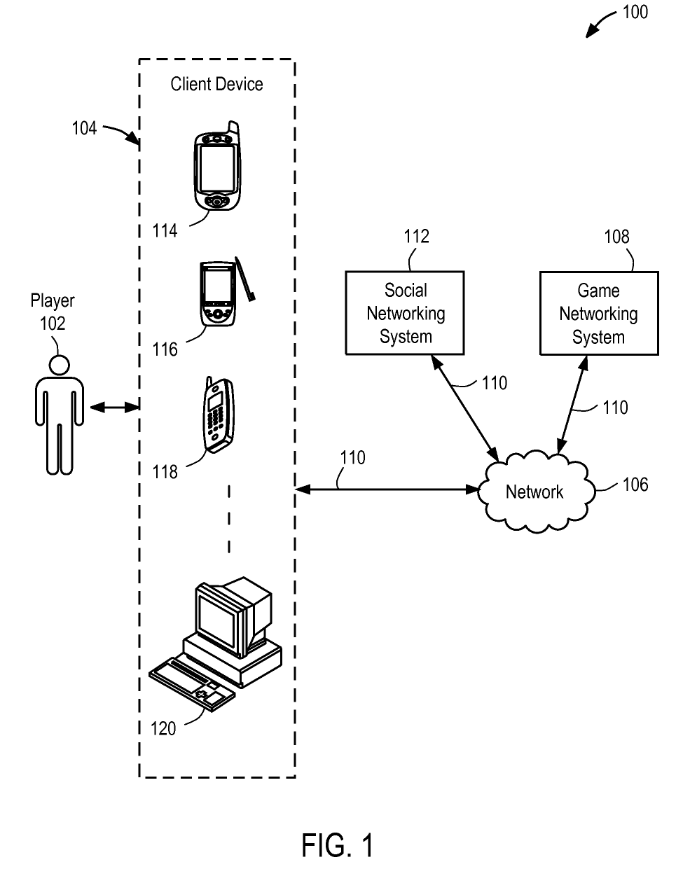

FIG. 1 is a schematic diagram showing an example of a system 100 for implementing various example embodiments. In some embodiments, the system 100 comprises a player 102, a client device 104, a network 106, a social networking system 112, and a game networking system 108. The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 114-120), such as a smart phone 114, a personal digital assistant (PDA) 116, a mobile phone 118, a personal computer 120, a laptop, a computing tablet, or any other device suitable for playing a virtual game. The client device 104 may access the social networking system 112 or the game networking system 108 directly, via the network 106, or via a third-party system. For example, the client device 104 may access the game networking system 108 via the social networking system 112.

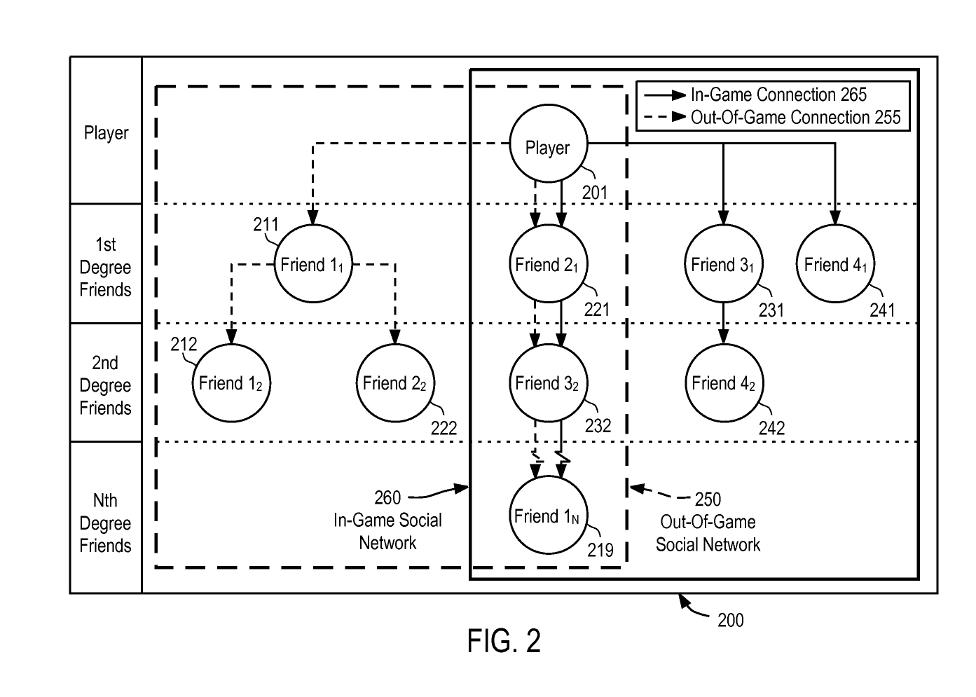

The social networking system 112 may include a network-addressable computing system that can host one or more social graphs (see for example FIG. 2), and may be accessed by the other components of system 100 either directly or via the network 106. The social networking system 112 may generate, store, receive, and transmit social networking data. Moreover, the game networking system 108 may include a network-addressable computing system (or systems) that can host one or more virtual games, for example, online games. The game networking system 108 may generate, store, receive, and transmit game-related data, such as, for example, game account data, game input, game state data, and game displays. The game networking system 108 may be accessed by the other components of system 100 either directly or via the network 106. The player 102 may use the client device 104 to access, send data to, and receive data from the social networking system 112 and/or the game networking system 108.

Although FIG. 1 illustrates a particular example of the arrangement of the player 102, the client device 104, the social networking system 112, the game networking system 108, and the network 106, this disclosure includes any suitable arrangement or configuration of the player 102, the client device 104, the social networking system 112, the game networking system 108, and the network 106.

FIG. 2 is a schematic diagram showing an example of a social network within a social graph 200. The social graph 200 is shown by way of example to include an out-of-game social network 250 and an in-game social network 260. Moreover, in-game social network 260 may include one or more players that are friends with Player 201 (e.g., Friend 231), and may include one or more other players that are not friends with Player 201. The social graph 200 may correspond to the various players associated with one or more virtual games. In an example embodiment, each player may communicate with other players. When, for example, Player 201 initiates a transfer of a game-related asset to Friend 231, the game networking system 108 may perform the transfer of the game-related asset from Player 201 to Friend 231.

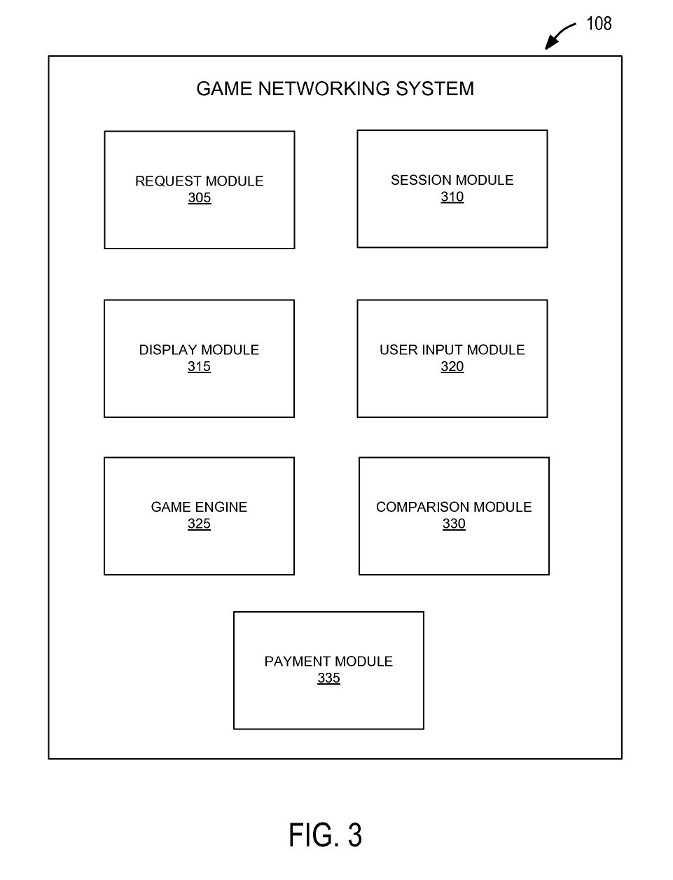

FIG. 3 is a block diagram showing example components of a game networking system 108. Game networking system 108 may include a request module 305, a session module 310, a display module 315, a user input module 320, a game engine 325, a comparison module 330, and a payment module 335.

The request module 305 may be configured to receive a request from a player to participate in a game instance of an online game. In various embodiments, the game instance comprises a plurality of game sessions and a plurality of sub-games. The game may also feature one or more opponent players. In various embodiments, if the game instance of the online game has not been generated, it may be generated by the game engine 325 in response to the request. In various embodiments, the player may be playing in a previous game instance and is requesting to participate in a new game instance. The request may be sent from a client device of the player via the network 106. Upon receiving the request, the game networking system 108 may forward the request to the game engine 325.

The session module 310 may be configured to manage or control a session counter corresponding to each player. The session module 310 may increment the session counter for each player during or after each session of the game instance in which each player participates but does not post a predetermined bet prior to the start of the session. For example, if the online game is poker, the session counter may be incremented for each hand of poker the player plays but does not post a bet (e.g., a small blind or a big blind) that a subset of the players at his poker table must post prior to the hand. In various embodiments, the session module 310 may also increment the session counter during or after each session of an additional or previous game instance in which the player plays but does not post a predetermined bet prior to each session. Therefore, the session counter may track game sessions played by the player across more than one game instance, including the current game instance and the additional game instance. In various embodiments, the amount that the session counter is incremented may vary. Moreover, the session module 310 may reset the session counter once the player has made a payment, as further described below. Alternatively, the session module 310 may reduce the session counter by a predetermined amount once the player has made a payment, as further described below.

The display module 315 may be configured to control information or data that is provided to client systems for display on a client device. For example, the display module 315 may be configured to provide display data associated with displaying a game instance of a game, displaying a user interface for selecting a game location, etc. In various embodiments, the display module 315 may present to the player currently playing in a first game instance an option to participate in a second game instance. Or the display module 315 may present the player with an option to move from a first sub-game of the first game instance or second game instance to a second sub-game of the first game instance or the second game instance, respectively. The option may also be known as a “jump.” The option may be displayed within the first game instance as a button labeled “jump.” The player may click the button and send a request to the request module 305 to participate in the second game instance or sub-game. In various embodiments, the display module 315 may display the option to “jump” based on the player's actions, such as when a player folds a hand in the poker game. For example, if the player participates in four sessions of poker after folding four times, the option to “jump” may be presented to the player. In various embodiments, if the player rejects the option to participate in the second game instance or sub-game, the option may still be presented by the display module 315 the next time the triggering event occurs. The session module 310 may track the number of times the player rejects the option to “jump.” If the player rejects the option to “jump” a predetermined number of times, the display module 315 may no longer display the option.

The user input module 320 may be configured to receive user inputs for processing by the game engine 325 based on rules of the game. For example, the user input module 320 may receive user inputs indicating functions, such as a move made by a player, selections of game locations chosen by a player, etc.

The game engine 325 may be configured to control any aspect of a game based on rules of the game, including how a game is played, players' actions and responses to players' actions, and the like. The game engine 325 may be configured to generate the game instance of a game of a player and may determine the progression of a game based on user inputs and rules of the game.

In various embodiments, the game engine 325 may include the player in the game instance of the online game in response to the request to participate in the game instance received at the request module 305. The game instance may be generated by the game engine 325. In various embodiments, the game engine 325 may also move the player from a first game instance to a second game instance of the online game in response to a “jump” request. Or the game engine 325 may move the player from a first sub-game of the first or second game instance to a second sub-game of the first or second game instance.

In various embodiments, the game engine 325 may require the player to have a threshold number of game assets prior to allowing the player to move between game instances or sub games. Game assets may include anything that has value in the online game, such as poker chips, a number of points, and the like. In the event that the player does not satisfy the threshold number of game assets, the player may acquire additional game assets. The player may purchase the additional game assets from the game networking system 108. Alternatively, the player may have more than one account registered with the game networking system 108 and may reallocate game assets from another registered account. In various embodiments, as the player is playing the online game, the player may acquire additional options to “jump” by purchasing them from the online game. Alternatively, the additional options may simply accrue as the player plays the online game. In various embodiments, the game engine 325 may place a limit on the number of times the player can exercise the option to “jump.” For example, the player may only have a maximum of 10 options to “jump,” even if the player tries to acquiring additional options to “jump.” Therefore, the player may purchase additional options to “jump” from the game networking system 108 as long as it does not exceed the limit. In various embodiments, the player may purchase an unlimited number of options to “jump” from the game networking system 108. In doing so, the game engine 325 does not limit the number of times the player can exercise the option to “jump.”

The comparison module 330 may be configured to compare session counters. In various embodiments, the comparison module 330 may compare the session counter corresponding to the player to one or more session counters corresponding to opponent players in the game instance, and the one or more session counters each may count a number of sessions played by an opponent player in which the opponent player did not place a mandatory bet required by a subset of players of a game session. In various embodiments, the session counter corresponding to the player may be greatest, may be second greatest, or may be less than second greatest when compared to the one or more session counters corresponding to the opponent players. In various embodiments, the session counter corresponding to the player may be equal to at least one session counter among the one or more session counters corresponding to the opponent players.

The payment module 335 may be configured to determine a payment owed based on the comparing of the session counters. The payment module may determine the payment owed to be a first value if the session counter corresponding to the player is greatest compared to the session counters corresponding to the opponent players. The first value may be a largest bet (e.g., a big blind bet) that is required of a subset of the players of a sub-game (e.g., a poker table) of the game instance (e.g., a multiple-table Texas Hold 'Em poker game instance). Alternatively, the payment module 335 may determine the payment owed to be a second value if the session counter corresponding to the player is second greatest compared to the session counters corresponding to the opponent players. The second value may be a second largest bet (e.g., a small big blind bet) that is required of a subset of the players of the sub-game of the game instance. Lastly, the payment module 335 may determine that there is no payment owed if the session counter corresponding to the player is less than second greatest compared to the session counters corresponding to the opponent players. For example, if only two mandatory bets are required of the players of a sub-game of a game, and a player's session counter does not have one of the two highest session counter values of all of the other players of the sub-game, then the player may not be required to place a bet at the start of the game session. As stated previously, the session module 310 may reset the session counter of a player once the player has made the payment. Alternatively, the session module 310 may reduce the session counter of a player by a predetermined amount once the player has made the payment. In various embodiments, if the session counter corresponding to the player is tied with at least one session counter among the session counters corresponding to the opponent players as being the greatest or second greatest, then the payment module 335 may assign the payment to a player at random. For example, if the session counter corresponding to the player is tied with two session counters corresponding to two opponent players as having the greatest value, a payment equal to the first value (or big blind) may be assigned randomly to one of the players. In various embodiments, the first value and the second value may vary based on the game instance. For example, a first game instance may have a lower first value and lower second value as compared to a second game instance. Moreover, if the player “jumps” to a new game instance, the first value and the second value at the new game instance may be different than the first value and the second value at a previous game instance. In various embodiments, the payment module 335 may also collect a payment from the player based on the player exercising the option to participate in the second game instance of the online game.

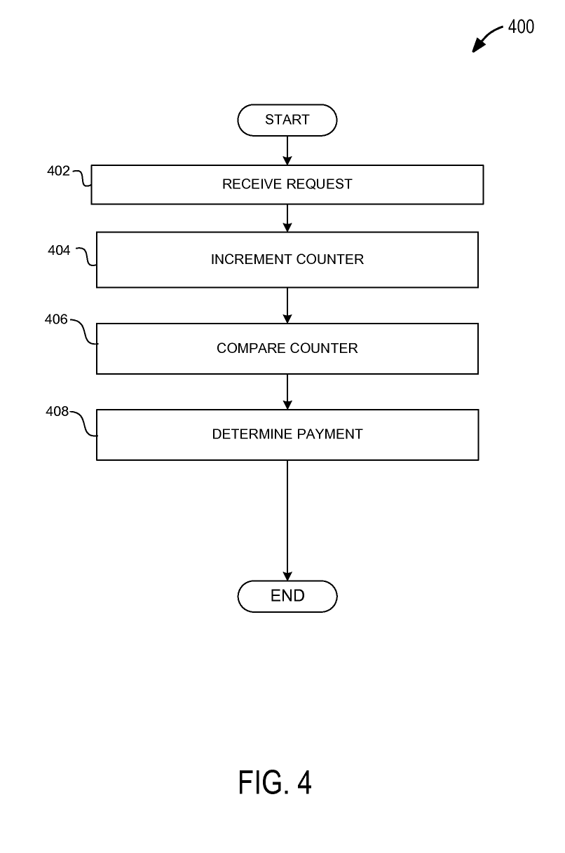

FIG. 4 is a flowchart showing an example method 400 of determining a payment owed by a player, according to some embodiments. At operation 402 of the method 400, the request module 305 may receive a request from a player operating a client device. In various embodiments, the request is to participate in a first game instance of an online game. At operation 404, the session module 310 may increment a session counter after each session of the game instance in which the first player plays. The session counter may count the number of game sessions played by the player in which the player does not make a payment (or bet) that was required to be placed by a subset of the players of the game session in which the player played. At operation 406, the comparison module may compare the session counter of the player to one or more additional session counters of one or more additional players respectively. In various embodiments, the one or more additional session counters each count a number of sessions played by each opponent player in which each opponent player did not place a mandatory bet required by a subset of players of a game session in which the opponent player played. At operation 408, the payment module may determine a payment owed by the player based on the comparing the session counters by the comparison module at operation 406.

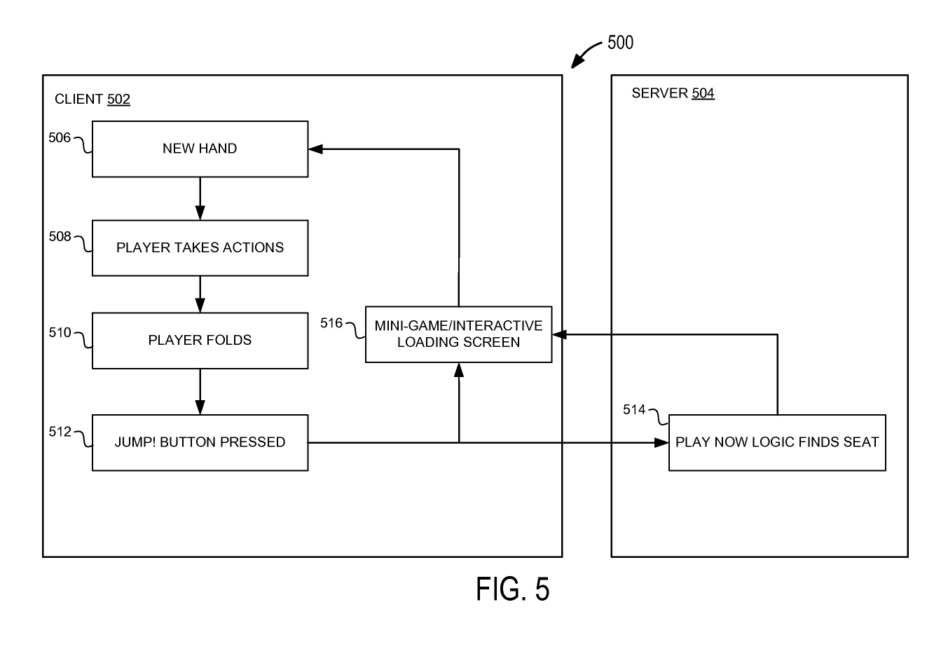

FIG. 5 is flowchart showing an example method 500 to perform a “jump” from one game instance or sub-game to another game instance or sub-game, according to some embodiments. Operations 506, 508, 510, 512, and 516 may be performed on a client device 502. Operation 514 may be performed by a server 504, such as a game server. The online game may be a poker game. At operation 506 of method 500, a new hand is dealt to the player and displayed on the client device 502. At operation 508, the player may take actions based on the rules of the game. At operation 510, the player may fold the hand dealt. In response to the player folding, the game engine 325 may present to the player an option to “jump” to another game instance or sub-game. At operation 512, the player may press the “jump” button, which results in a sending of a request to the server 504. At operation 514, the request module 305 may receive the request from the player to “jump” to or join another game instance or sub-game of the online game. The game engine 325 may conduct a search to find other game instances or sub-games for the player to join. Once a game instance or sub-game has been found, the server may send display information to the client device from a display module 315 to indicate that the game instance or sub-game has been found. As a result, at operation 516, a loading screen is presented to the player on the client device 502.

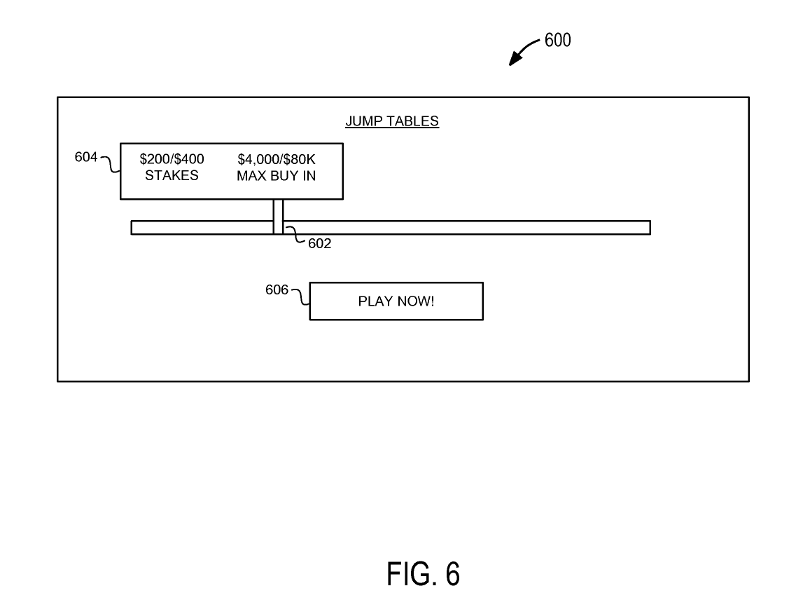

FIG. 6 is a user interface diagram 600 illustrating an example game user interface presenting a selection bar 602 from which a user may select a different game instance of sub-game to jump to, according to some embodiments. The selection bar 602 may slide horizontally. The position of the bar indicates which game instance or sub-game that the player will jump to. Information 604 regarding the stakes associated with each game instance or sub-game may also be displayed. For example, the bar 602 indicates that the player has selected a game instance or sub-game having stakes of maximum of $4,000 and a buy-in of $80K. In various embodiments, as the bar 602 slides horizontally to the left, the stakes may decrease. Similarly, as the bar 602 slides horizontally to the right, the stakes may increase. Once the game to jump to is selected by the user, the user may begin playing the game by clicking button 606.

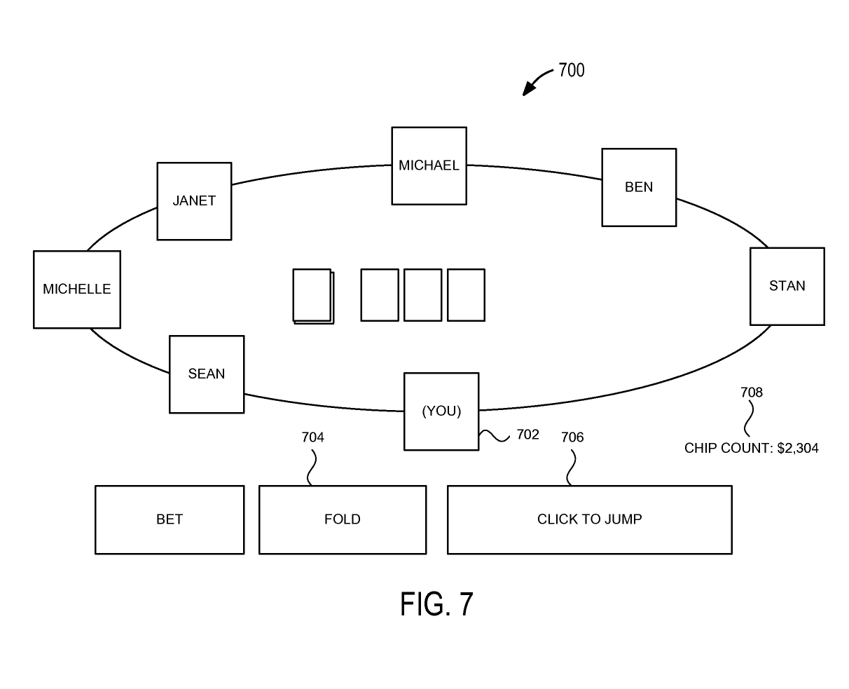

FIG. 7 is a user interface diagram 700 illustrating an example game user interface with an option to “jump,” according to some embodiments. The user interface depicts a game of poker at a poker table (the game instance or sub-game) where the player 702 is playing. The game of poker at the poker table may be played as a plurality of sessions or rounds and the table may include other players, as depicted in 700. In various embodiments, the player 702 may be presented with a “jump” button 706. The button 706 may appear in response to the player's actions, such as the player folding a hand by clicking on button 704. In various embodiments, the “jump” button is only presented when the player folds a predetermined number of hands (e.g., four hands) in a row. Moreover, once the player 702 clicks on the “jump” button 706, the game engine 325 may determine whether the player has a threshold number of game assets 708 prior to allowing the player to move to another game instance.

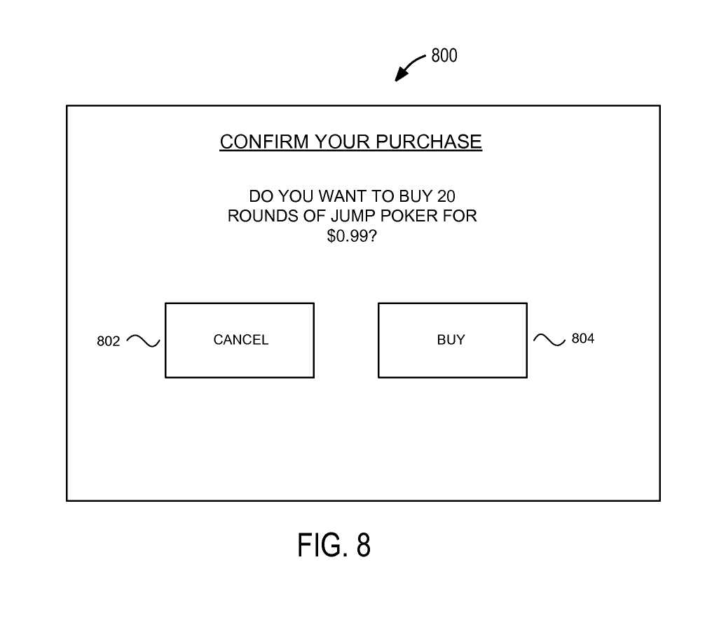

FIG. 8 is a user interface diagram 800 illustrating an example game user interface in which a player may opt to enable the “jump” feature, according to some embodiments. In various embodiments, a player will not be able to jump between game instances or sub-games unless the “jump” feature is enabled. In various embodiments, the player may enable the jump feature by purchasing it. In various embodiments, the user interface diagram 800 may be presented to the user after the user exercises the option to “jump” by clicking on button 706 of FIG. 7. The user interface diagram 800 may be displayed in response to the game engine 325 determining that the user has no more “jumps” available to use. In response the user may either cancel the purchase by clicking on button 802 or confirm the purchase by clicking on button 804.

A database may store any data relating to game play within a game networking system 108. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 108 may determine the player's friend preferences based on player attributes that the player's first-degree friends have in common, and may store these player attributes as friend preferences in the player profile. Furthermore, the game networking system 108 may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 108 may determine the player's likelihood to lead value based on information from other players that interact with this player. For example, the game networking system 108 may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 108 may also determine the player's likelihood to lead value based on information about the player's interactions with others and the outcome of these interactions. For example, the game networking system 108 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108 may determine the player's likelihood to lead value based on determining a likelihood for the other players to perform a certain action in response to interacting or communicating with the player and/or the player's virtual environment.

In a multiplayer game, players control player characters (PCs), a game engine controls non-player characters (NPCs). The game engine also manages player character state and tracks states for currently active (e.g., online) players and currently inactive (e.g., offline) players. A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits, or the obtaining of some assets (e.g., health, money, strength, inventory, land, etc.). A game engine may determine the outcome of a game event according to game rules (e.g., “a character with less than 5 health points will be prevented from initiating an attack”), based on a character's state, and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on Player A's team (e.g., the friends that are listed as being in the player's mob/gang/set/army/business/crew/etc. depending on the nature of the game) may be playing the virtual game and choose to confront Player B who has 20 friends on Player B's team. In some embodiments, a player may only have first-degree friends on the player's team. In other embodiments, a player may also have second-degree and higher degree friends on the player's team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

A virtual game may be hosted by the game networking system 108, which can be accessed using any suitable connection 110 with a suitable client device 104. A player may have a game account on the game networking system 108, wherein the game account may contain a variety of information associated with the player (e.g., the player's personal information, financial information, purchase history, player character state, game state, etc.). In some embodiments, a player may play multiple games on the game networking system 108, which may maintain a single game account for the player with respect to the multiple games, or multiple individual game accounts for each game with respect to the player. In some embodiments, the game networking system 108 may assign a unique identifier to a player 102 of a virtual game hosted on the game networking system 108. The game networking system 108 may determine that the player 102 is accessing the virtual game by reading the user's cookies, which may be appended to HTTP requests transmitted by the client device 104, and/or by the player 102 logging onto the virtual game.

In some embodiments, the player 102 accesses a virtual game and control the game's progress via the client device 104 (e.g., by inputting commands to the game at the client device 104). The client device 104 can display the game interface, receive inputs from the player 102, transmit user inputs or other events to the game engine, and receive instructions from the game engine. The game engine can be executed on any suitable system (such as, for example, the client device 104, the social networking system 112, the game networking system 108). For example, the client device 104 may download client components of a virtual game, which are executed locally, while a remote game server, such as the game networking system 108, provides backend support for the client components and may be responsible for maintaining application data of the game, processing the inputs from the player 102, updating and/or synchronizing the game state based on the game logic and each input from the player 102, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player is only accessible by that specific player. For example, a first player may access a first game instance when playing a virtual game, and this first game instance may be inaccessible to all other players. In other embodiments, a game instance associated with a specific player is accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player is different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine interfaces with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in a multiplayer game.

In some embodiments, the social graph is managed by the game networking system 108, which is managed by the game operator. In other embodiments, the social graph is part of a social networking system 112 managed by a third party (e.g., Facebook, Friendster, Myspace). In yet other embodiments, the player 102 has a social network on both the game networking system 108 and the social networking system 112, wherein the player 102 can have a social network on the game networking system 108 that is a subset, superset, or independent of the player's social network on the social networking system 112. In such combined systems, game networking system 108 can maintain social graph information with edge-type attributes that indicate whether a given friend is an “in-game friend,” an “out-of-game friend,” or both. The various embodiments disclosed herein are operable when the social graph is managed by the social networking system 112, the game networking system 108, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 112.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network are formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

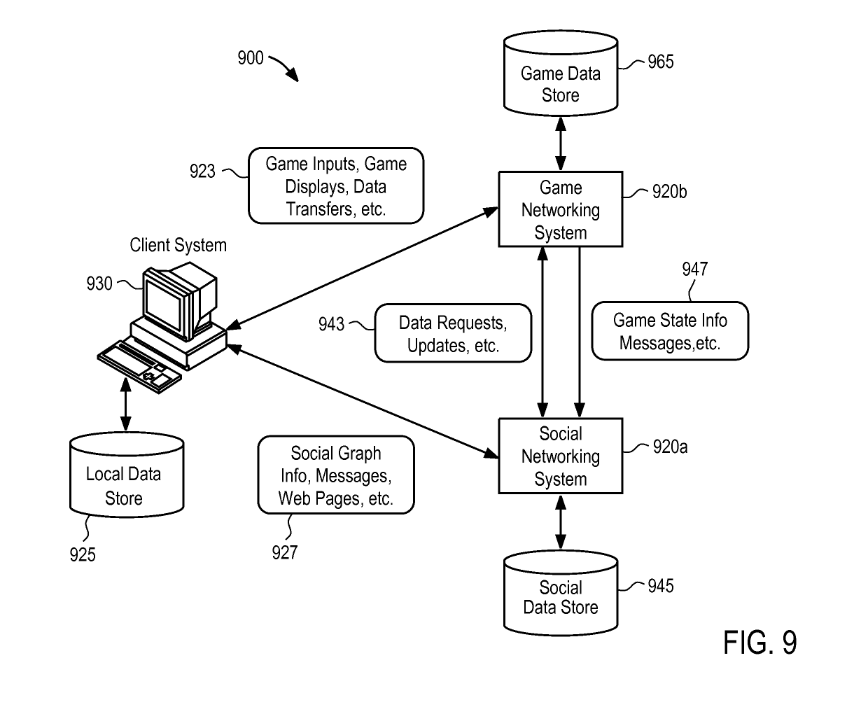

FIG. 9 is a diagrammatic representation of an example data flow between example components of an example system 900. One or more of the components of the example system 900 may correspond to one or more of the components of the example system 100. In some embodiments, system 900 includes a client system 930, a social networking system 920a, and a game networking system 920b. The components of system 900 can be connected to each other in any suitable configuration, using any suitable type of connection. The components may be connected directly or over any suitable network. The client system 930, the social networking system 920a, and the game networking system 920b may have one or more corresponding data stores such as the local data store 925, the social data store 945, and the game data store 965, respectively.

The client system 930 may receive and transmit data 923 to and from the game networking system 920b. This data can include, for example, a web page, a message, a game input, a game display, a HTTP packet, a data request, transaction information, and other suitable data. At some other time, or at the same time, the game networking system 920b may communicate data 943, 947 (e.g., game state information, game system account information, page info, messages, data requests, updates, etc.) with other networking systems, such as the social networking system 920a (e.g., FACEBOOK, MYSPACE, etc.). The client system 930 can also receive and transmit data 927 to and from the social networking system 920a. This data can include, for example, web pages, messages, social graph information, social network displays, HTTP packets, data requests, transaction information, updates, and other suitable data.

Communication between the client system 930, the social networking system 920a, and the game networking system 920b can occur over any appropriate electronic communication medium or network using any suitable communications protocols. For example, the client system 930, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses a virtual game on the game networking system 920b, the BLOB containing the game state for the instance corresponding to the player may be transmitted to the client system 930 for use by a client-side executed object to process. In some embodiments, the client-side executable is a FLASH™-based game, which can de-serialize the game state data in the BLOB. As a player plays the game, the game logic implemented at the client system 930 maintains and modifies the various game state parameters locally. The client-side game logic may also batch game events, such as mouse clicks, and transmit these events to the game networking system 920b. Game networking system 920b may itself operate by retrieving a copy of the BLOB from a database or an intermediate memory cache (memcache) layer. The game networking system 920b can also de-serialize the BLOB to resolve the game state parameters and execute its own game logic based on the events in the batch file of events transmitted by the client to synchronize the game state on the server side. The game networking system 920b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a player selects one or more actions to perform. The web pages may be displayed in a browser client executed on the client system 930. For example, a client application downloaded to the client system 930 may operate to serve a set of web pages to a player. As another example, a virtual game may be an animated or rendered game executable as a stand-alone application or within the context of a webpage or other structured document. In some embodiments, the virtual game is implemented using ADOBE™ FLASH™-based technologies. As an example, a game may be fully or partially implemented as a SWF object that is embedded in a web page and executable by a FLASH™ media player plug-in. In some embodiments, one or more described web pages is associated with or accessed by the social networking system 920a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at the client system 930, either caused by an action of a game player or by the game logic itself, the client system 930 may need to inform the game networking system 920b of the update. For example, if the game is a farming game with a harvest mechanic (such as ZYNGA™ FARMVILLE™), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as any one of an ADOBE™ FLASH™ object, MICROSOFT™ SILVERLIGHT™ object, HTML 5 object, etc. FLASH™ may manipulate vector and raster graphics and support bidirectional streaming of audio and video. “FLASH™” may mean the authoring environment, the player, or the application files. In some embodiments, the client system 930 may include a FLASH™ client. The FLASH™ client may be configured to receive and run FLASH™ application or game object code from any suitable networking system (such as, for example, the social networking system 920a or the game networking system 920b). In some embodiments, the FLASH™ client is run in a browser client executed on the client system 930. A player can interact with FLASH™ objects using the client system 930 and the FLASH™ client. The FLASH™ objects can represent a variety of in-game objects. Thus, the player may perform various in-game actions on various in-game objects by making various changes and updates to the associated FLASH™ objects.

In some embodiments, in-game actions are initiated by clicking or similarly interacting with a FLASH™ object that represents a particular in-game object. For example, a player can interact with a FLASH™ object to use, move, rotate, delete, attack, shoot, or harvest an in-game object. This disclosure contemplates performing any suitable in-game action by interacting with any suitable FLASH™ object. In some embodiments, when the player makes a change to a FLASH™ object representing an in-game object, the client-executed game logic may update one or more game state parameters associated with the in-game object. To ensure synchronization between the FLASH™ object shown to the player at the client system 930, the FLASH™ client may send the events that caused the game state changes to the in-game object to the game networking system 920b. However, to expedite the processing and hence the speed of the overall gaming experience, the FLASH™ client may collect a batch of some number of events or updates into a batch file. The number of events or updates may be determined by the FLASH™ client dynamically or determined by the game networking system 920b based on server loads or other factors. For example, client system 930 may send a batch file to the game networking system 920b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to player data or metadata, changes to player social connections or contacts, player inputs to the game, and events generated by the game logic. In some embodiments, each application datum has a name and a value. The value of an application datum may change at any time in response to the game play of a player or in response to the game engine (e.g., based on the game logic). In some embodiments, an application data update occurs when the value of a specific application datum is changed.

In some embodiments, when a player plays a virtual game on the client system 930, the game networking system 920b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular player and a particular virtual game. In some embodiments, while a player is not playing the virtual game, the corresponding BLOB may be stored in the database. This enables a player to stop playing the game at any time without losing the current state of the game the player is in. When a player resumes playing the game next time, game networking system 920b may retrieve the corresponding BLOB from the database to determine the most-recent values of the game-related data. In some embodiments, while a player is playing the virtual game, the game networking system 920b also loads the corresponding BLOB into a memory cache so that the game system may have faster access to the BLOB and the game-related data contained therein.

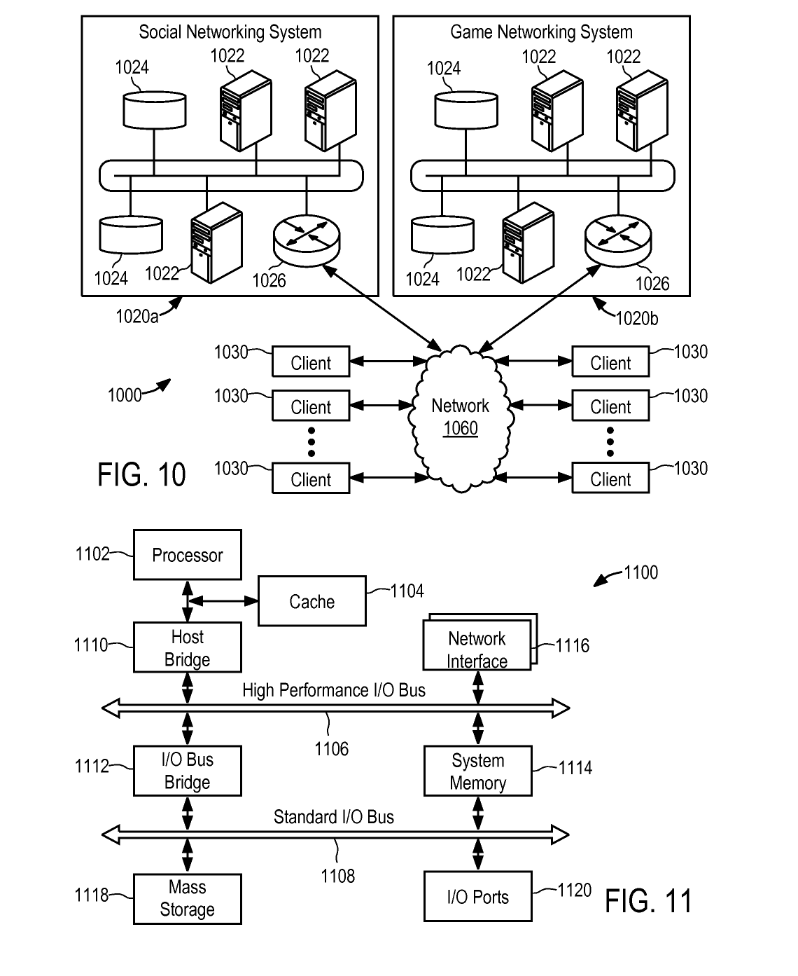

Various embodiments may operate in a wide area network environment, such as the Internet, including multiple network addressable systems. FIG. 10 is a schematic diagram showing an example network environment 1000, in which various example embodiments may operate. Network cloud 1060 generally represents one or more interconnected networks, over which the systems and hosts described herein can communicate. Network cloud 1060 may include packet-based wide area networks (such as the Internet), private networks, wireless networks, satellite networks, cellular networks, paging networks, and the like. As FIG. 10 illustrates, various embodiments may operate in a network environment 1000 comprising one or more networking systems, such as a social networking system 1020a, a game networking system 1020b, and one or more client systems 1030. The components of the social networking system 1020a and the game networking system 1020b operate analogously; as such, hereinafter they may be referred to simply as the networking system 1020. The client systems 1030 are operably connected to the network environment 1000 via a network service provider, a wireless carrier, or any other suitable means.

The networking system 1020 is a network addressable system that, in various example embodiments, comprises one or more physical servers 1022 and data stores 1024. The one or more physical servers 1022 are operably connected to computer network cloud 1060 via, by way of example, a set of routers and/or networking switches 1026. In an example embodiment, the functionality hosted by the one or more physical servers 1022 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), FLASH™, ActionScript, and the like.

The physical servers 1022 may host functionality directed to the operations of the networking system 1020. Hereinafter servers 1022 may be referred to as server 1022, although the server 1022 may include numerous servers hosting, for example, the networking system 1020, as well as other content distribution servers, data stores, and databases. Data store 1024 may store content and data relating to, and enabling operation of, the networking system 1020 as digital data objects. A data object, in some embodiments, is an item of digital information typically stored or embodied in a data file, database, or record. Content objects may take many forms, including: text (e.g., ASCII, SGML, HTML), images (e.g., JPEG, TIF and GIF), graphics (vector-based or bitmap), audio, video (e.g., MPEG), or other multimedia, and combinations thereof. Content object data may also include executable code objects (e.g., games executable within a browser window or frame), podcasts, etc.

Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In some embodiments, data store 1024 may be implemented by any suitable physical system(s) including components, such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

The client system 1030 is generally a computer or computing device including functionality for communicating (e.g., remotely) over a computer network. The client system 1030 may be a desktop computer, laptop computer, personal digital assistant (PDA), in- or out-of-car navigation system, smart phone or other cellular or mobile phone, or mobile gaming device, among other suitable computing devices. Client system 1030 may execute one or more client applications, such as a Web browser.

When a user at a client system 1030 desires to view a particular webpage (hereinafter also referred to as target structured document) hosted by the networking system 1020, the user's web browser, or other document rendering engine or suitable client application, formulates and transmits a request to the networking system 1020. The request generally includes a URL or other document identifier as well as metadata or other information. By way of example, the request may include information identifying the user, a timestamp identifying when the request was transmitted, and/or location information identifying a geographic location of the user's client system 1030 or a logical network location of the user's client system 1030.

Although the example network environment 1000 described above and illustrated in FIG. 10 is described with respect to the social networking system 1020a and the game networking system 1020b, this disclosure encompasses any suitable network environment using any suitable systems. For example, a network environment may include online media systems, online reviewing systems, online search engines, online advertising systems, or any combination of two or more such systems.

FIG. 11 is a block diagram illustrating an example computing system architecture, which may be used to implement a server 1022 or a client system 1030. In one embodiment, the hardware system 1100 comprises a processor 1102, a cache memory 1104, and one or more executable modules and drivers, stored on a tangible computer-readable storage medium, directed to the functions described herein. Additionally, the hardware system 1100 may include a high performance input/output (I/O) bus 1106 and a standard I/O bus 1108. A host bridge 1110 may couple the processor 1102 to the high performance I/O bus 1106, whereas the I/O bus bridge 1112 couples the two buses 1106 and 1108 to each other. A system memory 1114 and one or more network/communication interfaces 1116 may couple to the bus 1106. The hardware system 1100 may further include video memory (not shown) and a display device (not shown) coupled to the video memory. Mass storage 1118 and I/O ports 1120 may couple to the bus 1108. The hardware system 1100 may optionally include a keyboard, a pointing device, and a display device (not shown) coupled to the bus 1108. Collectively, these elements are intended to represent a broad category of computer hardware systems.

The elements of the hardware system 1100 are described in greater detail below. In particular, the network interface 1116 provides communication between the hardware system 1100 and any of a wide range of networks, such as an Ethernet (e.g., IEEE 802.3) network, a backplane, etc. The mass storage 1118 provides permanent storage for the data and programming instructions to perform the above-described functions implemented in servers 1122 of FIG. 11, whereas system memory 1114 (e.g., DRAM) provides temporary storage for the data and programming instructions when executed by the processor 1102. I/O ports 1120 are one or more serial and/or parallel communication ports that provide communication between additional peripheral devices, which may be coupled to the hardware system 1100.

The hardware system 1100 may include a variety of system architectures and various components of the hardware system 1100 may be rearranged. For example, cache memory 1104 may be on-chip with the processor 1102. Alternatively, the cache memory 1104 and the processor 1102 may be packed together as a “processor module,” with processor 1102 being referred to as the “processor core.” Furthermore, certain embodiments of the present disclosure may neither require nor include all of the above components. For example, the peripheral devices shown coupled to the standard I/O bus 1108 may couple to the high performance I/O bus 1106. In addition, in some embodiments, only a single bus may exist, with the components of the hardware system 1100 being coupled to the single bus. Furthermore, the hardware system 1100 may include additional components, such as additional processors, storage devices, or memories.

An operating system manages and controls the operation of the hardware system 1100, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising:
selecting a player seeking to participate in a session of an instance of a game to make a payment associated with the session of the instance of the game, the selecting based on a session counter of the selected player having a higher value than a session counter of an unselected player seeking to participate in the session of the game, the session counter of the selected player representing a value of payments that the selected player was not selected to pay in previous sessions of the instance of the game, the session counter of the unselected player representing a value of payments that the unselected player was not selected to pay in the previous sessions of the instance of the game;
based on a receiving of the payment from the selected player, decrementing the session counter of the selected player by an amount corresponding to the payment, incrementing the value of the session counter of the additional player by an amount corresponding to the payment, and allowing the selected player and the unselected player to participate in the session of the instance of the game.

2. The method of claim 1, wherein the session counter of the selected player further represents a value of payments that the player was not selected to pay in previous sessions of an additional instance of the game from which the player jumped to the instance of the game.

3. The method of claim 1, wherein the game is a card game and the session of the instance of the game is a hand of the card game.

4. The method of claim 3, wherein the payment associated with the session of the game is a blind bet.

5. The method of claim 1, further comprising notifying the selected player of an option to jump to one of a set of additional instances of the game, each of the set of additional instances of the game having a different attribute than the instance of the game.

6. The method of claim 5, wherein the attribute comprises at least one of a stake amount and a buy-in amount.

7. The method of claim 5, wherein the notifying of the selected player of the option to jump to one of the set of additional instances of the game is based on the selected player performing a triggering action and the selected player having an amount of a game asset that transgresses a threshold.

8. A system comprising:
a payment module configured to select a player seeking to participate in a session of an instance of a game to make a payment associated with the session of the instance of the game,
the selecting based on a session counter of the selected player having a higher value than a session counter of an unselected player seeking to participate in the session of the game, the session counter of the selected player representing a value of payments that the selected player was not selected to pay in previous sessions of the instance of the game, the session counter of the unselected player representing a value of payments that the unselected player was not selected to pay in the previous sessions of the instance of the game;
a session module configured to decrement the session counter of the selected player by an amount corresponding to the payment based on a receiving of the payment from the selected player, and increment the value of the session counter of the additional player by an amount corresponding to the payment; and
a game engine configured to allow the selected player and the unselected player to participate in the session of the instance of the game.

9. The system of claim 8, wherein the session counter of the selected player further represents a value of payments that the player was not selected to pay in previous sessions of an additional instance of the game from which the player jumped to the instance of the game.

10. The system of claim 8, wherein the game is a card game and the session of the instance of the game is a hand of the card game.

11. The system of claim 10, wherein the payment associated with the session of the game is a blind bet.

12. The system of claim 8, further comprising a display module configured to notify the selected player of an option to jump to one of a set of additional instances of the game, each of the set of additional instances of the game having a different attribute than the instance of the game.

13. The system of claim 12, wherein the attribute comprises at least one of a stake amount and a buy-in amount.

14. The system of claim 12, wherein the display module is further configured to notify the selected player of the option to jump to one of the set of additional instances of the game based on the selected player performing a triggering action and the selected player having an amount of a game asset that transgresses a threshold.

15. A non-transitory machine-readable medium storing instructions which, when executed by one or more processors, cause the one or more processors to perform operations comprising:
selecting a player seeking to participate in a session of an instance of a game to make a payment associated with the session of the instance of the game, the selecting based on a session counter of the selected player having a higher value than a session counter of an unselected player seeking to participate in the session of the game, the session counter of the selected player representing a value of payments that the selected player was not selected to pay in previous sessions of the instance of the game, the session counter of the unselected player representing a value of payments that the unselected player was not selected to pay in the previous sessions of the instance of the game;
based on a receiving of the payment from the selected player, decrementing the session counter of the selected player by an amount corresponding to the payment, incrementing the value of the session counter of the additional player by an amount corresponding to the payment, and allowing the selected player and the unselected player to participate in the session of the instance of the game.

16. The non-transitory machine-readable medium of claim 15, wherein the session counter of the selected player further represents a value of payments that the player was not selected to pay in previous sessions of an additional instance of the game from which the player jumped to the instance of the game.

17. The non-transitory machine-readable medium of claim 15, wherein the game is a card game and the session of the instance of the game is a hand of the card game.

18. The non-transitory machine-readable medium of claim 17, wherein the payment associated with the session of the game is a blind bet.

19. The non-transitory machine-readable medium of claim 15, wherein the operations further comprise notifying the selected player of an option to jump to one of a set of additional instances of the game, each of the set of additional instances of the game having a different attribute than the instance of the game.

20. The non-transitory machine-readable medium of claim 19, wherein the notifying of the selected player of the option to jump to one of the set of additional instances of the game is based on the selected player performing a triggering action and the selected player having an amount of a game asset that transgresses a threshold.
